(19) United States
(12) Patent Application Publication
(10) Pub. No.: US 2023/0017884 A1
(43) Pub. Date: Jan. 19, 2023

(54) METHOD AND SYSTEM FOR SEAMLESSLY REMOTE MONITORING AN AVAILABILITY OF A PUBLISHED REMOTE RESOURCE ON A HOST

(71) Applicant: ControlUp Technologies Ltd., Rishon LeTsiyon (IL)

(72) Inventor: Gadi FELDMAN, Beit Hanania (IL)

(21) Appl. No.: 17/811,881

(22) Filed: Jul. 12, 2022

Related U.S. Application Data
(60) Provisional application No. 63/221,042, filed on Jul. 13, 2021.

(51) Int. Cl. H04L 41/50

(52) U.S. Cl. CPC H04L 41/5093; H04L 41/5083

(57) ABSTRACT

A method for seamlessly remote monitoring an availability of a published remote resource on a host is disclosed. The method comprises: sending, from a remote monitoring entity, monitoring commands to the host, via a Remote Display Session (RDS) between the remote monitoring entity and the host, the RDS executing on a web page loaded by a headless browser running on the remote monitoring entity; and determining one or more availability parameters that are indicative of the availability of the published remote resource, by the remote monitoring entity, based on results of execution of the monitoring commands by the host.

### TECHNICAL FIELD

The invention relates to a method and system for seamlessly remote monitoring an availability of a published remote resource on a host.

### BACKGROUND

Current solutions for monitoring an availability of a published remote resource on a host by a remote monitoring entity require a remote desktop client to be opened on the remote monitoring entity. This limits usage of the remote monitoring entity by a user of the remote monitoring entity and is susceptible to malfunctions.

Accordingly, there is a need for a new method and system for seamlessly remote monitoring an availability of a published remote resource on a host.

References considered to be relevant as background to the presently disclosed subject matter are listed below. Acknowledgement of the references herein is not to be inferred as meaning that these are in any way relevant to the patentability of the presently disclosed subject matter.

U.S. Patent Application Publication No. 2016/0212073, published on Jul. 21, 2016, discloses a system for flexible and scalable automated end-to-end chat-based contact center testing, having a test case management platform, a chat cruncher, a contact center manager, a chat classifier, a desktop automation engine, and headless browser-based virtual agents and customers. The test case management platform allows a user to configure operation of the system. The chat cruncher operates a plurality of virtual customers. The contact center manager operates a plurality of virtual agents to participate in chat session with virtual customers.

U.S. Patent Application Publication No. 2020/0310945, published on Oct. 1, 2020, discloses methods, non-transitory computer readable media, and dashboard servers that initiate a test of a web application on a runner server in response to a command. A test action associated with the test includes a user input trigger and a hint. A user input request, generated when the user input trigger is encountered during execution of the test with a headless browser, is received from the runner server. The user input request includes a session identifier and the hint. Input data is obtained from a user device via an input field that is output along with the hint to an input panel provided to the user device. The input panel is associated with the session identifier. The input data is then sent to the runner server in response to the user input request.

U.S. Pat. No. 10,567,537, published on Feb. 18, 2020, discloses methods, systems, and computer-readable media for optimizing web pages using a rendering engine. In some embodiments, a cloud service computing platform may receive, via a communication interface and from a user device, a request for a web page. Subsequently, the cloud service computing platform may retrieve, via the communication interface, and from a server, the web page. Further, the cloud service computing platform may render, using a headless browser, the web page to identify a plurality of content parts associated with the web page. Next, the cloud service computing platform may optimize the plurality of content parts associated with the web page. Additionally, the cloud service computing platform may transmit, via the communication interface and to the user device, the plurality of optimized content parts associated with the web page. Subsequently, the user device may render the plurality of optimized content parts associated with the web page.

U.S. Patent Application Publication No. 2018/0077160, published on Mar. 15, 2018, discloses a method comprising: intercepting, from a server computer, a first set of instructions that define a user interface; executing, using a headless browser, the first set of instructions without presenting the user interface; rendering a second set of instructions, which when executed by a client application on a client computer, cause the client computer to present the user interface, wherein the second set of instructions are different than the first set of instructions; and sending the second set of instructions to the client computer.

### GENERAL DESCRIPTION

In accordance with a first aspect of the presently disclosed subject matter, there is provided a method for seamlessly remote monitoring an availability of a published remote resource on a host, the method comprising: sending, from a remote monitoring entity, monitoring commands to the host, via a Remote Display Session (RDS) between the remote monitoring entity and the host, the RDS executing on a web page loaded by a headless browser running on the remote monitoring entity; and determining one or more availability parameters that are indicative of the availability of the published remote resource, by the remote monitoring entity, based on results of execution of the monitoring commands by the host.

In some cases, the availability parameters include one or more of: an ability or inability of the remote monitoring entity to connect to the host, a log-on duration of connecting the remote monitoring entity to the host, a processing capability of a Central Processing Unit (CPU) of the host, an available bandwidth of communication between the remote monitoring entity and the host, a network latency of communication between the remote monitoring entity and the host, or a Round Trip Time (RTT) between the sending of the monitoring commands to the host by the remote monitoring entity and an obtaining of data by the remote monitoring entity responsive to the monitoring commands.

In some cases, the method further comprises triggering an alert to a user of the remote monitoring entity upon the remote monitoring entity determining that at least one of the availability parameters is indicative of an alert requiring situation.

In some cases, the alert requiring situation is that the results of execution of the monitoring commands indicate one or more of the following: an inability of the remote monitoring entity to connect to the host, a log-on duration of connecting the remote monitoring entity to the host that is greater than a log-on threshold, an available bandwidth of communication between the remote monitoring entity and the host that is below a bandwidth threshold, a network latency of communication between the remote monitoring entity and the host that is greater than a latency threshold, a processing capability of a Central Processing Unit (CPU) of the host that is above a processing capability threshold, a Round Trip Time (RTT) between the sending of the monitoring commands to the host by the remote monitoring entity and an obtaining of data by the remote monitoring entity responsive to an execution of the monitoring commands being greater than a RTT threshold, or a given difference greater than a threshold difference between a respective availability parameter of the availability parameters and a historical availability parameter that is based on results of at least one past determination of the respective availability parameter.

In some cases, the monitoring commands include one or more of: a log-on command requesting that the host connect to the remote monitoring entity, a mouse movement command instructing the host to move a mouse cursor over the published remote resource, a mouse click command instructing the host to perform a mouse click over the published remote resource, a computer program execution command instructing the host to execute a computer program that is capable of being executed on one or more of the host or the published remote resource, opening a document on the host, or running a report on the published remote resource.

In some cases, the headless browser is run in one of the following: a docker, a service mode, a container, or a lambda function.

In some cases, the remote monitoring entity and the host are not connected to a common organizational network.

In some cases, the method further comprises: obtaining additional data, by the remote monitoring entity, from an agent that is installed on a Gateway (GW) between the host and the remote monitoring entity, at least some of the additional data not being accessible to the remote monitoring entity directly from the host, wherein the GW and the host are connected to the common organizational network, thereby enabling the agent to obtain the additional data from the host; wherein one or more of the availability parameters are determined based on the additional data.

In some cases, the additional data includes one or more of: a processing capability of a CPU of the host, a log-on duration of connecting the remote monitoring entity to the host, or metadata of the host or the published remote resource.

In some cases, the RDS is one of: VMware Blast Extreme, Microsoft Remote Desktop Protocol (RDP), Teradici Personal Computer Over Internet Protocol (PCoIP), or Citrix High Definition Experience over Independent Computing Architecture (HDX/ICA).

In accordance with a second aspect of the presently disclosed subject matter, there is provided a remote monitoring entity for seamlessly remote monitoring an availability of a published remote resource on a host, the remote monitoring entity comprising a processing circuitry configured to: send monitoring commands to the host, via a Remote Display Session (RDS) between the remote monitoring entity and the host, the RDS executing on a web page loaded by a headless browser running on the remote monitoring entity; and determine one or more availability parameters that are indicative of the availability of the published remote resource, based on results of execution of the monitoring commands by the host.

In some cases, the availability parameters include one or more of: an ability or inability of the remote monitoring entity to connect to the host, a log-on duration of connecting the remote monitoring entity to the host, a processing capability of a Central Processing Unit (CPU) of the host, an available bandwidth of communication between the remote monitoring entity and the host, a network latency of communication between the remote monitoring entity and the host, or a Round Trip Time (RTT) between the sending of the monitoring commands to the host by the remote monitoring entity and an obtaining of data by the remote monitoring entity responsive to the monitoring commands.

In some cases, the processing circuitry is further configured to: trigger an alert to a user of the remote monitoring entity upon determining that at least one of the availability parameters is indicative of an alert requiring situation.

In some cases, the alert requiring situation is that the results of execution of the monitoring commands indicate one or more of the following: an inability of the remote monitoring entity to connect to the host, a log-on duration of connecting the remote monitoring entity to the host that is greater than a log-on threshold, an available bandwidth of communication between the remote monitoring entity and the host that is below a bandwidth threshold, a network latency of communication between the remote monitoring entity and the host that is greater than a latency threshold, a processing capability of a Central Processing Unit (CPU) of the host that is above a processing capability threshold, a Round Trip Time (RTT) between the sending of the monitoring commands to the host by the remote monitoring entity and an obtaining of data by the remote monitoring entity responsive to an execution of the monitoring commands being greater than a RTT threshold, or a given difference greater than a threshold difference between a respective availability parameter of the availability parameters and a historical availability parameter that is based on results of at least one past determination of the respective availability parameter.

In some cases, the monitoring commands include one or more of: a log-on command requesting that the host connect to the remote monitoring entity, a mouse movement command instructing the host to move a mouse cursor over the published remote resource, a mouse click command instructing the host to perform a mouse click over the published remote resource, a computer program execution command instructing the host to execute a computer program that is capable of being executed on one or more of the host or the published remote resource, opening a document on the host, or running a report on the published remote resource.

In some cases, the headless browser is run in one of the following: a docker, a service mode, a container, or a lambda function.

In some cases, the remote monitoring entity and the host are not connected to a common organizational network.

In some cases, the processing circuitry is further configured to: obtain additional data from an agent that is installed on a Gateway (GW) between the host and the remote monitoring entity, at least some of the additional data not being accessible to the remote monitoring entity directly from the host, wherein the GW and the host are connected to the common organizational network, thereby enabling the agent to obtain the additional data from the host; wherein one or more of the availability parameters are determined based on the additional data.

In some cases, the additional data includes one or more of: a processing capability of a CPU of the host, a log-on duration of connecting the remote monitoring entity to the host, or metadata of the host or the published remote resource.

In some cases, the RDS is one of: VMware Blast Extreme, Microsoft Remote Desktop Protocol (RDP), Teradici Personal Computer Over Internet Protocol (PCoIP), or Citrix High Definition Experience over Independent Computing Architecture (HDX/ICA).

In accordance with a third aspect of the presently disclosed subject matter, there is provided a non-transitory computer readable storage medium having computer readable program code embodied therewith, the computer readable program code, executable by a processing circuitry of a remote monitoring entity to perform a method for seamlessly remote monitoring an availability of a published remote resource on a host, the method comprising: sending, from the remote monitoring entity, monitoring commands to the host, via a Remote Display Session (RDS) between the remote monitoring entity and the host, the RDS executing on a web page loaded by a headless browser running on the remote monitoring entity; and determining one or more availability parameters that are indicative of the availability of the published remote resource, by the remote monitoring entity, based on results of execution of the monitoring commands by the host.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic diagram illustrating an example of an environment for seamless remote monitoring of an availability of a published remote resource that is running on a host, in accordance with the presently disclosed subject matter,

FIG. 2 is a block diagram schematically illustrating one example of a remote monitoring entity, in accordance with the presently disclosed subject matter,

FIG. 3 is a schematic diagram illustrating an example of another environment for seamless remote monitoring of an availability of a published remote resource that is running on a host, in accordance with the presently disclosed subject matter, and

FIG. 4 is a flowchart illustrating one example of a sequence of operations for seamlessly remote monitoring an availability of a published remote resource that is running on a host, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “sending”, “determining”, “triggering”, “requesting”, “obtaining” or the like, include actions and/or processes, including, inter alia, actions and/or processes of a computer, that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

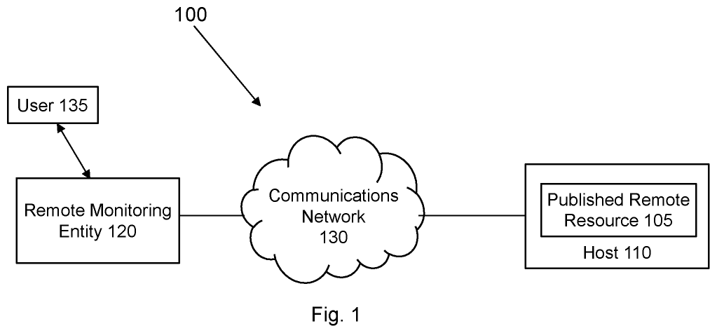

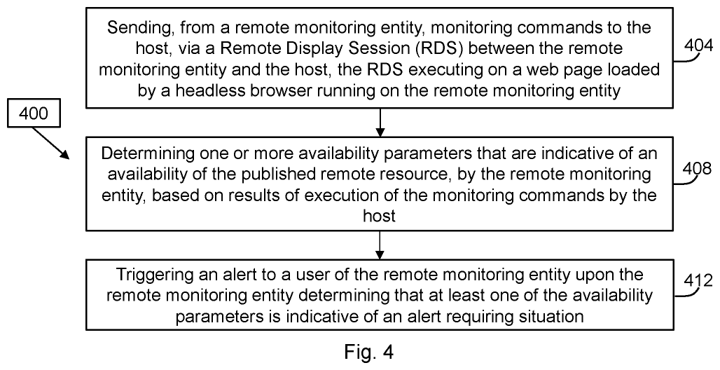

In embodiments of the presently disclosed subject matter, fewer, more and/or different stages than those shown in FIG. 4 may be executed. FIGS. 1 to 3 illustrate a general schematic of the system architecture in accordance with an embodiment of the presently disclosed subject matter. Each module in FIGS. 1 to 3 can be made up of any combination of software, hardware and/or firmware that performs the functions as defined and explained herein. The modules in FIGS. 1 to 3 may be centralized in one location or dispersed over more than one location. In other embodiments of the presently disclosed subject matter, the system may comprise fewer, more, and/or different modules than those shown in FIGS. 1 to 3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this is mind, attention is now drawn to FIG. 1, a schematic diagram illustrating an example of an environment 100 for seamless remote monitoring of an availability of a published remote resource 105 that is running on a host 110, in accordance with the presently disclosed subject matter.

In accordance with the presently disclosed subject matter, a remote monitoring entity 120 can be configured to remotely connect to and control the host 110 over a communications network 130, via a Remote Display Session (RDS) between the remote monitoring entity 120 and the host 110 that is executed by the remote monitoring entity 120 in a manner that is seamless to a user 135 of the remote monitoring entity 120 (i.e., the user 135 does not need to open a remote desktop client to instruct the remote monitoring entity 120 to execute the RDS). The remote monitoring entity 120 can be configured to remotely connect to and control the host 110 for remotely monitoring the availability of the published remote resource 105 that is running on the host 110. In order to execute the RDS in a manner that is seamless to the user 135, remote monitoring entity 120 can execute the RDS on a web page that is loaded by a headless browser running on the remote monitoring entity 120. In some cases, the published remote resource 105 can be one or more of: a full desktop of the host 110, one or more operating systems that are running on the host 110, or one or more applications that are running on the host 110.

In some cases, the communications network 130 can be a common organizational network to which the remote monitoring entity 120 and the host 110 are connected. For the purposes of this disclosure, a common organizational network is defined as a network that locally connects computer resources (client workstations, servers, printers, other computer peripherals, etc.) to enable the computer resources to locally communicate with one another without accessing an Internet. If the remote monitoring entity 120 and the host 110 are connected to a common organizational network, the remote monitoring entity 120 can be capable of detecting availability parameters that are indicative of the availability of the published remote resource 105 (referred to herein, interchangeably, as “availability parameters”) based on data that is obtained by the remote monitoring entity 120 directly from the host 110.

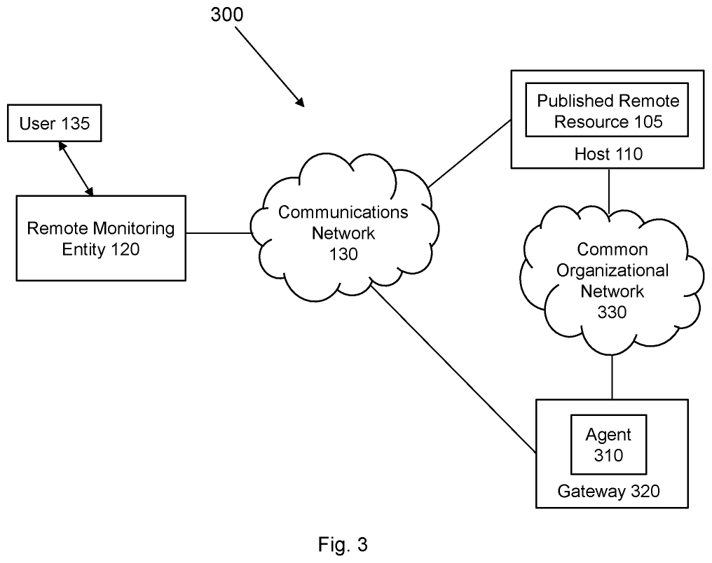

In some cases, the remote monitoring entity 120 and the host 110 are not connected to a common organizational network (e.g., the remote monitoring entity 120 connects to the host 110 via the Internet). This can result in the remote monitoring entity 120 being incapable of determining some of the availability parameters that are indicative of the availability of the published remote resource 105 based on data that is obtained by the remote monitoring entity 120 directly from the host 110. A non-limiting solution for allowing the remote monitoring entity 120 to determine these availability parameters is detailed further herein, inter alia with reference to FIG. 3.

In some cases, the headless browser running on the remote monitoring entity 120 can be run in one of the following: a docker, a service mode, a container, or a lambda function.

In some cases, the RDS can be one of: VMware Blast Extreme, Microsoft Remote Desktop Protocol (RDP). Teradici Personal Computer Over Internet Protocol (PCoIP), or Citrix High Definition Experience over Independent Computing Architecture (HDX/ICA).

A user 135 of the remote monitoring entity 120 can provide instructions to the remote monitoring entity 120, and can receive data from the remote monitoring entity 120, including, inter alia, alerts that are indicative of insufficient availability of the published remote resource 105.

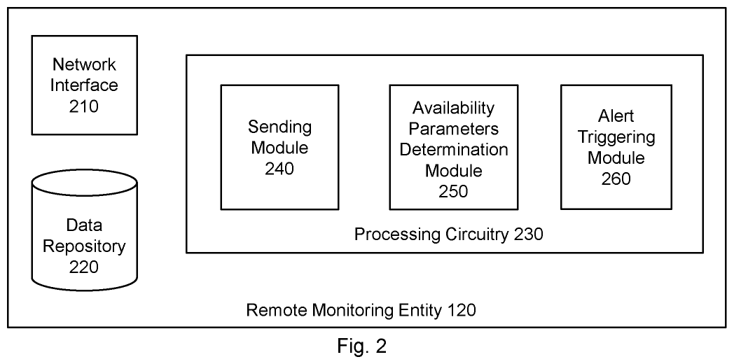

Attention is now drawn to FIG. 2, a block diagram schematically illustrating one example of a remote monitoring entity 120, in accordance with the presently disclosed subject matter.

In accordance with the presently disclosed subject matter, remote monitoring entity 120 comprises a network interface 210 that is configured to connect the remote monitoring entity 120 to communications network 130, through which the remote monitoring entity 120 can connect to the host 110 and other computerized devices.

The network interface 210 can be configured to enable the remote monitoring entity 120 to send data and receive data sent thereto through the communications network 130.

In some cases, remote monitoring entity 120 can comprise, or be otherwise associated with, a data repository 220 (e.g. a database, a storage system, a memory including Read Only Memory—ROM, Random Access Memory—RAM, or any other type of memory, etc.) configured to store data, optionally including, inter alia, data that enables the remote monitoring entity 120 to determine the availability parameters that are indicative of an alert requiring situation, as detailed further herein, inter alia with reference to FIG. 4. Data repository 220 can be further configured to enable retrieval and/or updating and/or deletion of the stored data. It is to be noted that in some cases, data repository 220 can be distributed, while the remote monitoring entity 120 has access to the information stored thereon, e.g., via a wired or wireless network to which remote monitoring entity 120 is able to connect (utilizing its network interface 210).

Remote monitoring entity 120 also comprises a processing circuitry 230. Processing circuitry 230 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant remote monitoring entity 120 resources and for enabling operations related to remote monitoring entity 120 resources.

Processing circuitry 230 can be configured to include a sending module 240. Processing circuitry 230 can be configured, e.g. using sending module 240, to send monitoring commands to the host 110, via the RDS between the remote monitoring entity 120 and the host 110. Additional details regarding the monitoring commands are provided further herein, inter alia with reference to FIG. 4.

Processing circuitry 230 can also be configured to include an availability parameters determination module 250. Processing circuitry 230 can be configured, e.g. using availability parameters determination module 250, to determine one or more availability parameters that are indicative of an availability of the published remote resource 105, based on results of execution of the monitoring commands by the host 110, as detailed further herein, inter alia with reference to FIG. 4.

Moreover, processing circuitry 230 can be configured to include an alert triggering module 260. Processing circuitry 230 can be configured, e.g. using alert triggering module 260, to trigger an alert to a user 135 of the remote monitoring entity 120 upon the remote monitoring entity 120 determining that at least one of the availability parameters is indicative of an alert requiring situation, as detailed further herein, inter alia with reference to FIG. 4.

Attention is now drawn to FIG. 3, a schematic diagram illustrating an example of another environment 300 for seamless remote monitoring of an availability of a published remote resource 105 that is running on a host 110, in accordance with the presently disclosed subject matter.

In accordance with the presently disclosed subject matter, in some cases, remote monitoring entity 120 can be configured to connect to the host 110 over a communications network 130 that is not a common organizational network. For example, remote monitoring entity 120 can be configured to connect to the host 110 over the Internet. This can result in the remote monitoring entity 120 being incapable of detecting at least some of the availability parameters that are indicative of the availability of the published remote resource 105 based on data that is obtained by the remote monitoring entity 120 directly from the host 110.

In some cases, in order to allow the remote monitoring entity 120 to determine such availability parameters, an agent 310 can be installed on a Gateway (GW) 320 between the host 110 and the remote monitoring entity 120, wherein the GW 320 and the host 110 are connected to a common organizational network 330, and wherein the GW 320 and the remote monitoring entity 120 are connected to a communications network 130 (e.g., the Internet) that is different than the common organizational network 330.

In some cases, agent 310 can be configured to obtain additional data from the host 110, at least some of which the remote monitoring entity 120 is not capable of obtaining directly from the host 110. The additional data that the remote monitoring entity 120 may not be capable of obtaining directly from the host 110 can be, for example, a log-on duration of connecting remote monitoring entity 120 to the host 110, a processing capability of a Central Processing Unit (CPU) of the host 110, metadata from the host 110 or the published remote resource 105, and/or any other characteristics of the host 110 that can only be determined by a computing device that is connected to the same common organizational network as the host 110. In some cases, remote monitoring entity 120 can be configured to obtain the additional data from the agent 310, upon a request by the remote monitoring entity 120 from the agent 310 for the additional data. Alternatively, in some cases, agent 310 can be configured to send data associated with all of the sessions that are running on the host 110 to the remote monitoring entity 120, and the remote monitoring entity 120 can be configured to select the additional data from the agent 310 that is relevant to the RDS between the remote monitoring entity 120 and the host 110.

In some cases, remote monitoring entity 120 can be configured to determine one or more of the availability parameters, based on the additional data. Additionally, or alternatively, in some cases, agent 310 can be configured to determine one or more of the availability parameters, such availability parameters being the additional data, and to provide such availability parameters to the remote monitoring entity 120 (thereby enabling the remote monitoring entity 120 to determine the availability parameters).

A user 135 of the remote monitoring entity 120 can provide instructions to the remote monitoring entity 120, and can receive data from the remote monitoring entity 120, as detailed earlier herein, inter alia with reference to FIG. 1.

Attention is now drawn to FIG. 4, a flowchart illustrating one example of a sequence of operations 400 for seamlessly remote monitoring an availability of a published remote resource 105 that is running on a host 110, in accordance with the presently disclosed subject matter.

In accordance with the presently disclosed subject matter, remote monitoring entity 120 can be configured, e.g. using sending module 240, to send monitoring commands to the host 110, optionally periodically (e.g., every hour, every minute, once a week at a given time (e.g., 8 AM on Monday morning), any combination of the foregoing, etc.) or according to a pattern or rules (e.g. if the user 135 of the remote monitoring entity 120 is connected or it is expected that the user 135 may connect at any time, the monitoring commands can be sent every minute; otherwise, the monitoring commands can be sent every hour). The monitoring commands are sent to the host 110 via a Remote Display Session (RDS) between the remote monitoring entity 120 and the host 110, the RDS executing on a web page loaded by a headless browser running on the remote monitoring entity 120 (block 404). In this manner, the execution of the RDS is seamless to the user 135 of the remote monitoring entity 120.

In some cases, the monitoring commands can include one or more of: a log-on command requesting that the host 110 connect to the remote monitoring entity 120, a mouse movement command instructing the host 110 to move a mouse cursor over the published remote resource 105, a mouse click command instructing the host 110 to perform a mouse click over the published remote resource 105, a computer program execution command instructing the host 110 to execute a computer program (e.g., application) that is capable of being executed on the host 110 and/or on the published remote resource 105, opening a document on the host 110, or running a report on the published remote resource 105.

Remote monitoring entity 120 can also be configured, e.g. using availability parameters determination module 250, to determine one or more availability parameters that are indicative of an availability of the published remote resource 105, based on results of execution of the monitoring commands by the host 110 (block 408).

In some cases, the availability parameters can include one or more of: an ability or inability of the remote monitoring entity 120 to connect to the host 110, a log-on duration of connecting remote monitoring entity 120 to the host 110, a processing capability of a Central Processing Unit (CPU) of the host 110, an available bandwidth of communication between the remote monitoring entity 120 and the host 110, a network latency of communication between the remote monitoring entity 120 and the host 110, or a Round Trip Time (RTT) between the sending of the monitoring commands to the host 110 by the remote monitoring entity 120 and an obtaining of data by the remote monitoring entity 120 responsive to the monitoring commands (e.g., a time duration between the sending of a mouse click command by the remote monitoring entity 120 to the host 110 and the occurrence of the mouse click command, performed at the host 110, at the remote monitoring entity 120).

Remote monitoring entity 120 can be configured to determine the availability parameters based on data received from the host 110 or additional data received from the agent 310. In some cases, at least some of the additional data can be one or more of the availability parameters. That is, the agent 310 itself can be configured to determine one or more of the availability parameters. In some cases, the additional data that is received by the agent 310 can include one or more of: a processing capability of a CPU of the host 110, a log-on duration of connecting the remote monitoring entity 120 to the host 110, or metadata of the host 110 or the published remote resource 105.

In some cases, processing circuitry 230 can be configured, e.g. using alert triggering module 260, to trigger an alert to a user 135 of the remote monitoring entity 120 upon the remote monitoring entity 120 determining that at least one of the availability parameters is indicative of an alert requiring situation.

In some cases, the alert requiring situation can be that the results of the execution of the monitoring commands indicates one or more of the following: an inability of the remote monitoring entity 120 to connect to the host 110, a log-on duration of connecting remote monitoring entity 120 to the host 110 that is greater than a log-on threshold, an available bandwidth of communication between the remote monitoring entity 120 and the host 110 that is below a bandwidth threshold, a network latency of communication between the remote monitoring entity 120 and the host 110 that is greater than a latency threshold, a processing capability of the CPU of the host 110 that is above a processing capability threshold, or a Round Trip Time (RTT) between the sending of the monitoring commands to the host 110 by the remote monitoring entity 120 and the obtaining of data by the remote monitoring entity 120 responsive to the execution of the monitoring commands that is greater than a RTT threshold.

Additionally, or alternatively, in some cases, the alert requiring situation can be that the results of the execution of the monitoring commands include a determination, by the remote monitoring entity 120, that a given difference between a respective availability parameter that is indicative of the availability of the published remote resource 105 and a historical availability parameter that is based on results of at least one past determination of the respective availability parameter is greater than a threshold difference.

It is to be noted that, with reference to FIG. 4, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagrams are described also with reference to the system elements that realize them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method for seamlessly remote monitoring an availability of a published remote resource on a host, the method comprising:
sending, from a remote monitoring entity, monitoring commands to the host, via a Remote Display Session (RDS) between the remote monitoring entity and the host, the RDS executing on a web page loaded by a headless browser running on the remote monitoring entity; and
determining one or more availability parameters that are indicative of the availability of the published remote resource, by the remote monitoring entity, based on results of execution of the monitoring commands by the host.

2. The method of claim 1, wherein the availability parameters include one or more of: an ability or inability of the remote monitoring entity to connect to the host, a log-on duration of connecting the remote monitoring entity to the host, a processing capability of a Central Processing Unit (CPU) of the host, an available bandwidth of communication between the remote monitoring entity and the host, a network latency of communication between the remote monitoring entity and the host, or a Round Trip Time (RTT) between the sending of the monitoring commands to the host by the remote monitoring entity and an obtaining of data by the remote monitoring entity responsive to the monitoring commands.

3. The method of claim 1, further comprising triggering an alert to a user of the remote monitoring entity upon the remote monitoring entity determining that at least one of the availability parameters is indicative of an alert requiring situation.

4. The method of claim 3, wherein the alert requiring situation is that the results of execution of the monitoring commands indicate one or more of the following: an inability of the remote monitoring entity to connect to the host, a log-on duration of connecting the remote monitoring entity to the host that is greater than a log-on threshold, an available bandwidth of communication between the remote monitoring entity and the host that is below a bandwidth threshold, a network latency of communication between the remote monitoring entity and the host that is greater than a latency threshold, a processing capability of a Central Processing Unit (CPU) of the host that is above a processing capability threshold, a Round Trip Time (RTT) between the sending of the monitoring commands to the host by the remote monitoring entity and an obtaining of data by the remote monitoring entity responsive to an execution of the monitoring commands being greater than a RTT threshold, or a given difference greater than a threshold difference between a respective availability parameter of the availability parameters and a historical availability parameter that is based on results of at least one past determination of the respective availability parameter.

5. The method of claim 1, wherein the monitoring commands include one or more of: a log-on command requesting that the host connect to the remote monitoring entity, a mouse movement command instructing the host to move a mouse cursor over the published remote resource, a mouse click command instructing the host to perform a mouse click over the published remote resource, a computer program execution command instructing the host to execute a computer program that is capable of being executed on one or more of the host or the published remote resource, opening a document on the host, or running a report on the published remote resource.

6. The method of claim 1, wherein the headless browser is run in one of the following: a docker, a service mode, a container, or a lambda function.

7. The method of claim 1, wherein the remote monitoring entity and the host are not connected to a common organizational network.

8. The method of claim 7, further comprising:
obtaining additional data, by the remote monitoring entity, from an agent that is installed on a Gateway (GW) between the host and the remote monitoring entity, at least some of the additional data not being accessible to the remote monitoring entity directly from the host, wherein the GW and the host are connected to the common organizational network, thereby enabling the agent to obtain the additional data from the host; wherein one or more of the availability parameters are determined based on the additional data.

9. The method of claim 8, wherein the additional data includes one or more of: a processing capability of a CPU of the host, a log-on duration of connecting the remote monitoring entity to the host, or metadata of the host or the published remote resource.

10. The method of claim 1, wherein the RDS is one of: VMware Blast Extreme, Microsoft Remote Desktop Protocol (RDP), Teradici Personal Computer Over Internet Protocol (PCoIP), or Citrix High Definition Experience over Independent Computing Architecture (HDX/ICA).

11. A remote monitoring entity for seamlessly remote monitoring an availability of a published remote resource on a host, the remote monitoring entity comprising a processing circuitry configured to:
send monitoring commands to the host, via a Remote Display Session (RDS) between the remote monitoring entity and the host, the RDS executing on a web page loaded by a headless browser running on the remote monitoring entity; and
determine one or more availability parameters that are indicative of the availability of the published remote resource, based on results of execution of the monitoring commands by the host.

12. The remote monitoring entity of claim 11, wherein the availability parameters include one or more of: an ability or inability of the remote monitoring entity to connect to the host, a log-on duration of connecting the remote monitoring entity to the host, a processing capability of a Central Processing Unit (CPU) of the host, an available bandwidth of communication between the remote monitoring entity and the host, a network latency of communication between the remote monitoring entity and the host, or a Round Trip Time (RTT) between the sending of the monitoring commands to the host by the remote monitoring entity and an obtaining of data by the remote monitoring entity responsive to the monitoring commands.

13. The remote monitoring entity of claim 11, wherein the processing circuitry is further configured to:
trigger an alert to a user of the remote monitoring entity upon determining that at least one of the availability parameters is indicative of an alert requiring situation.

14. The remote monitoring entity of claim 13, wherein the alert requiring situation is that the results of execution of the monitoring commands indicate one or more of the following: an inability of the remote monitoring entity to connect to the host, a log-on duration of connecting the remote monitoring entity to the host that is greater than a log-on threshold, an available bandwidth of communication between the remote monitoring entity and the host that is below a bandwidth threshold, a network latency of communication between the remote monitoring entity and the host that is greater than a latency threshold, a processing capability of a Central Processing Unit (CPU) of the host that is above a processing capability threshold, a Round Trip Time (RTT) between the sending of the monitoring commands to the host by the remote monitoring entity and an obtaining of data by the remote monitoring entity responsive to an execution of the monitoring commands being greater than a RTT threshold, or a given difference greater than a threshold difference between a respective availability parameter of the availability parameters and a historical availability parameter that is based on results of at least one past determination of the respective availability parameter.

15. The remote monitoring entity of claim 11, wherein the monitoring commands include one or more of: a log-on command requesting that the host connect to the remote monitoring entity, a mouse movement command instructing the host to move a mouse cursor over the published remote resource, a mouse click command instructing the host to perform a mouse click over the published remote resource, a computer program execution command instructing the host to execute a computer program that is capable of being executed on one or more of the host or the published remote resource, opening a document on the host, or running a report on the published remote resource.

16. The remote monitoring entity of claim 11, wherein the headless browser is run in one of the following: a docker, a service mode, a container, or a lambda function.

17. The remote monitoring entity of claim 11, wherein the processing circuitry is further configured to:
obtain additional data from an agent that is installed on a Gateway (GW) between the host and the remote monitoring entity, at least some of the additional data not being accessible to the remote monitoring entity directly from the host, wherein the remote monitoring entity and the host are not connected to a common organizational network, and wherein the GW and the host are connected to the common organizational network, thereby enabling the agent to obtain the additional data from the host;
wherein one or more of the availability parameters are determined based on the additional data.

18. The remote monitoring entity of claim 17, wherein the additional data includes one or more of: a processing capability of a CPU of the host, a log-on duration of connecting the remote monitoring entity to the host, or metadata of the host or the published remote resource.

19. The remote monitoring entity of claim 11, wherein the RDS is one of: VMware Blast Extreme, Microsoft Remote Desktop Protocol (RDP), Teradici Personal Computer Over Internet Protocol (PCoIP), or Citrix High Definition Experience over Independent Computing Architecture (HDX/ICA).

20. A non-transitory computer readable storage medium having computer readable program code embodied therewith, the computer readable program code, executable by a processing circuitry of a remote monitoring entity to perform a method for seamlessly remote monitoring an availability of a published remote resource on a host, the method comprising:
sending, from the remote monitoring entity, monitoring commands to the host, via a Remote Display Session (RDS) between the remote monitoring entity and the host, the RDS executing on a web page loaded by a headless browser running on the remote monitoring entity; and
determining one or more availability parameters that are indicative of the availability of the published remote resource, by the remote monitoring entity, based on results of execution of the monitoring commands by the host.
